(19) United States
(12) Patent Application Publication
(10) Pub. No.: US 2024/0428222 A1
(43) Pub. Date: Dec. 26, 2024

(54) SYSTEMS, DEVICES, AND METHODS FOR LOCATION-BASED PAYMENT ACCESS

(71) Applicant: VeriFone, Inc., Wilmington, DE (US)

(72) Inventor: Santhosh Gillella, Naperville, IL (US)

(73) Assignee: VeriFone, Inc., Wilmington, DE (US)

(21) Appl. No.: 18/705,087

(22) PCT Filed: Oct. 29, 2021
(86) PCT No.: PCT/US2021/072119

§ 371 Date: Apr. 26, 2024

(51) Int. Cl. G06Q 20/32; H04B 7/08

(52) U.S. Cl. CPC G06Q 20/3224; H04B 7/0882

(57) ABSTRACT

A payment device, comprising: a housing; and a controller disposed within the housing and configured to: receive at least one location signal, the at least one location signal being based, at least in part, on an antenna signal and representing a location of a payment transceiver or a range between the payment transceiver and an antenna: determine, according to the at least one location signal, whether the location of the payment transceiver is within a payment processing zone; determine whether the payment device is an approved payment device such that the payment device is approved to process payments from the payment transceiver; and process a payment from the payment transceiver only if, at least, the payment transceiver is within the payment processing zone and the payment device is an approved payment device.

### BACKGROUND

Aspects and implementations of the present disclosure are generally directed to systems, devices, and methods for location-based payment access.

In day-to-day life, people often lose or misplace money (cash/coins), credit cards or debit cards etc. Children are particularly prone to misplace cash or reloadable money cards that can be used to buy lunch at school or purchase books at bookstore etc. Once lost, it can be difficult to find such payment methods again, and, even if found, the cash value of the card may be zero or less than that amount that was loaded onto the card before losing it. Lost or stolen cards can quickly be used at an unintended location by the person who found the card. Also, in the case of cash, the chances of finding it again, once lost, are very low.

In case of credit and debit cards issued by banks, card holders can block the cards to prevent unauthorized usage. But in case of gift cards or store credits, there might not be a card number available to track and block. And even credit cards and debit cards can be misused before the owner realizes they are missing and blocks them.

The advent of mobile and digital wallets has permitted the loading of cards onto a mobile device, where they can be used for contactless payments. This permits flexibility of transferring the cards to different device whenever the mobile device is lost. Similarly, the cash value from reloadable cards can be transferred from one device to other (e.g., a transit card on a mobile phone). However, this has not entirely resolved the problems misplaced cards or money being spent at unapproved locations before the owner completes the transfer.

Accordingly, there exists a need in the art for location-based payment access that only permits a particular payment method to be used in authorized locations.

### SUMMARY

According to an aspect, a payment device includes: a housing; and a controller disposed within the housing and configured to: receive at least one location signal, the at least one location signal being based, at least in part, on an antenna signal and representing a location of a payment transceiver or a range between the payment transceiver and an antenna; determine, according to the at least one location signal, whether the location of the payment transceiver is within a payment processing zone; determine whether the payment device is an approved payment device such that the payment device is approved to process payments from the payment transceiver; and process a payment from the payment transceiver only if, at least, the payment transceiver is within the payment processing zone and the payment device is an approved payment device.

In an example, the at least one location signal is the antenna signal.

In an example, the payment device is within the payment processing zone comprises determining the range between the payment transceiver and the antenna according to the antenna signal and comparing the range to a range threshold.

In an example, the at least one location signal is a plurality of antenna signals, respectively received from a plurality of antennas.

In an example, determining whether the payment device is within the payment processing zone comprises: determining a range between the payment transceiver and each antenna of the plurality of antennas; determining the location of the payment transceiver according to the range between the payment transceiver and each antenna of the plurality of antennas; and determining whether the location of the payment transceiver is within a boundary of the payment processing zone.

In an example, the location signal is encoded data representing a location of the payment device, wherein determining whether the payment device is within the payment processing zone comprises determining whether the location of the payment transceiver is within a boundary of the payment processing zone.

In an example, the payment device is an ultra-wide band tag or a smart device equipped with an ultra-wide band antenna.

In an example, determining whether the payment device is an approved payment device, comprises the step of querying a remote server for an approval status of the payment device with respect to the payment transceiver.

In an example, determining whether the payment device is an approved payment device, comprises the step of querying the payment transceiver for an approval status of the payment device with respect to the payment transceiver.

In an example, the controller is further configured to determine, according to the at least one location signal, whether the location of the payment transceiver is within a payment device approval zone, wherein the step of determining whether the payment device is an approved payment device occurs if the payment transceiver is within the payment device approval zone.

According to another aspect, a method for payment access according to location or range, includes: receiving at least one location signal, the at least one location signal being based, at least in part, on an antenna signal and representing a location of a payment transceiver or a range between the payment transceiver and an antenna; determining, according to the at least one location signal, whether the location of the payment transceiver is within a payment processing zone; determining whether a payment device is an approved payment device such that the payment device is approved to process payments from the payment transceiver; and processing a payment from the payment transceiver only if, at least, the payment transceiver is within the payment processing zone and the payment device is an approved payment device.

In an example, the at least one location signal is the antenna signal.

In an example, determining whether the payment device is within the payment processing zone comprises determining the range between the payment transceiver and the antenna according to the antenna signal and comparing the range to a range threshold.

In an example, the at least one location signal is a plurality of antenna signals, respectively received from a plurality of antennas.

In an example, determining whether the payment device is within the payment processing zone comprises: determining a range between the payment transceiver and each antenna of the plurality of antennas; determining the location of the payment transceiver from the range between the payment transceiver and each antenna of the plurality of antennas; and determining whether the location of the payment transceiver is within a boundary of the payment processing zone.

In an example, the location signal is encoded data representing a location of the payment device, wherein determining whether the payment device is within the payment processing zone comprises determining whether the location of the payment transceiver is within a boundary of the payment processing zone.

In an example, payment device is an ultra-wide band tag or a smart device equipped with an ultra-wide band antenna.

In an example, determining whether the payment device is an approved payment device, comprises the step of querying a remote server for an approval status of the payment device with respect to the payment transceiver.

In an example, determining whether the payment device is an approved payment device, comprises the step of querying the payment transceiver for an approval status of the payment device with respect to the payment transceiver.

In an example, the method further includes the step of determining, according to the at least one location signal, whether the location of the payment transceiver is within a payment device approval zone, wherein the step of determining whether the payment device is an approved payment device occurs if the payment transceiver is within the payment device approval zone.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the various embodiments.

FIG. 1 is a perspective view of examples of payment devices, according to an example.

FIG. 2 is a schematic view of a payment device, a payment processing zone, and a payment transceiver, according to an example.

FIG. 3A is a timing diagram of one-way ranging between an anchor, used for ranging in a payment system, and a payment transceiver, according to an example.

FIG. 3B is a timing diagram of two-way ranging between an anchor, used for ranging in a payment system, and a payment transceiver, according to an example.

FIG. 4 is a schematic view of a plurality of anchors, used for location detection in payment system, according to an example.

FIG. 5 is a schematic view of a payment processing zone, as implemented using the location detection from a plurality of anchors, in a payment system, according to an example.

FIG. 6 is a schematic view of a payment device, a payment processing zone, a payment device approval zone, and a payment transceiver, according to an example.

FIG. 7 is a schematic view of a of a payment device, according to an example.

FIG. 8A is a method for location-based payment access, according to an example.

FIG. 8B is a partial method for location-based payment access, according to an example.

FIG. 8C is a partial method for location-based payment access, according to an example.

FIG. 8D is a partial method for location-based payment access, according to an example.

FIG. 8E is a partial method for location-based payment access, according to an example.

### DETAILED DESCRIPTION

This disclosure generally relates to a payment system, payment device, and method for location-based payment access. More particularly, various examples relate to systems, devices, and methods for determining whether a payment transceiver is within a payment processing zone. Various examples further relate to pre-approving the payment device when the payment transceiver is within a payment device approval zone. Other examples and features of the invention will be further understood in conjunction with a review of this disclosure.

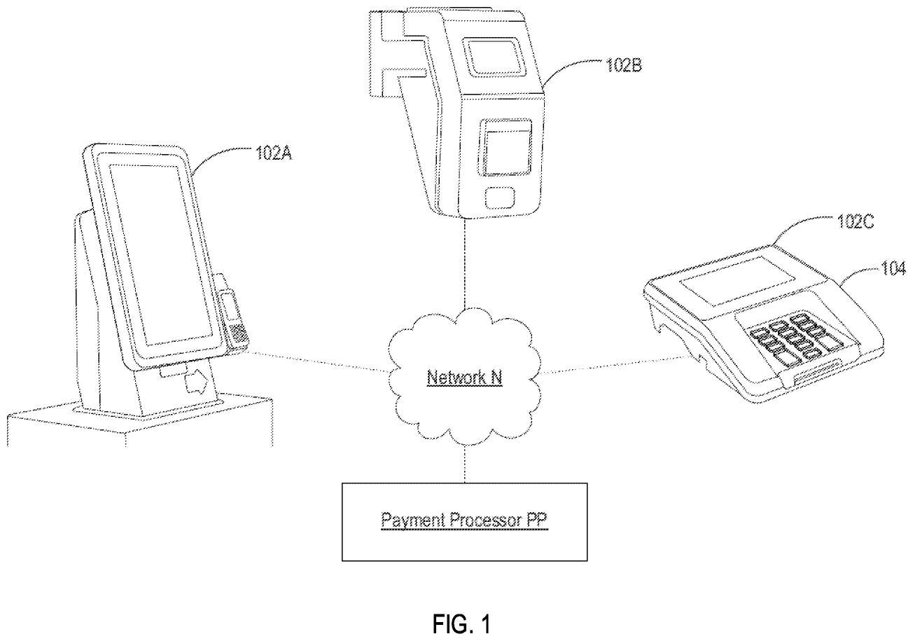

FIG. 1 is a perspective view of a payment system 100 according to the present disclosure. As shown in FIG. 1, payment system 100 can include one or more payment devices 102A-102C (hereinafter referred to in the collective as “payment devices 102” and/or in the singular as “payment device 102”). Each payment device 102 is configured to receive payment information from a user, e.g., a patron at a retail or dining establishment, and can transmit and/or receive payment data via a network N to and/or from a payment processor PP. For the purposes of this disclosure, payment device 102 communicating with a payment processor in an attempt to validate a payment is referred to as “processing” the payment (as this begins the payment processing). It should be understood that processing a payment can include communicating with the payment processor even if the payment processor ultimately denies the payment, because of insufficient funds, reaching a credit limit, etc. Network N can be any network suitable for communicating with the payment processor, such as a local area network (LAN), a wide area network (WAN), a 3G network, 4G/LTE network, and can include a plurality of devices and/or servers connected over the internet. It should be appreciated that the connections within and between the payment devices 102 of the network N can include wired or wireless communications.

Payment processor PP is intended to be a third-party processor, e.g., a party other than the user of the card, the business establishment, or the provider or the payment devices, that receives payment information from users and performs or handles the financial transaction between the source of funds of the user and the destination of the funds, e.g., the bank of the business establishment. As illustrated in FIG. 1, payment device 102A is shown as a fixed countertop kiosk and POS terminal, payment device 102B is shown as a payment kiosk, and payment device 102C is shown as a fixed multilane payment device and card reader. However, it should be appreciated that payment devices 102 can be selected from at least one of: a fixed or mounted point of sale (POS) terminal, a fixed or mounted POS device, a fixed or portable kiosk, a gas pump payment terminal or kiosk, a portable POS device or terminal, a mobile device (e.g., a tablet or smartphone), or any other device capable of reading payment data from a user's card (e.g., a credit or debit card) or other alternative payment methods such as PayPal, Stipe, Apple Pay, Alipay, Klarna, PaySafeCard, cryptocurrency, etc.

In various examples, payment device 102 includes an antenna, or receives data derived from one or more antennas, to determine whether a payment transceiver 104 is within a payment processing zone A, marked by boundary 106. Payment device 102 further determines whether it is approved for processing payments requested by the payment transceiver, by querying a remote server or payment transceiver 104 for an approval status of payment device 102. If payment transceiver 104 is within the payment processing zone A and the payment device 102 is approved to process payments from payment transceiver 104, payment device 102 processes the payment. If, however, the payment device 102 is not approved to process payments, then payments are denied.

Payment transceiver 104 can be any device that includes an antenna or antenna(s) can receive and transmit signals as necessary for range or location detection—i.e., suitable for determining whether payment transceiver is within payment processing zone A. In an example, payment transceiver can be an ultra-wide band (UWB) antenna tag or a smart device equipped with an UWB antenna. Generally, payment transceiver 104 must operate within a bandwidth that permits determination of the range or location of the payment transceiver with substantial accuracy (i.e., ±10 cm) to resolve potential ambiguities with respect to payment processing zones of other payment devices.

As described above, payment device 102 can determine whether it is an approved device for processing the transaction for a given payment transceiver 104. Stated differently, each payment transceiver 104 can be limited by a user to operate only with pre-selected payment devices 102. The payment devices 102 for which it can be used can be selected by a user, for example, via a smart device application or via a website—i.e., the user can configure the payment transceiver through communication with a remote server(s) 108 (over the cloud). When payment transceiver 104 is within payment processing zone A, payment device 102 can query the remote server(s) 108 to determine whether it is an approved payment device 102 completing the transaction. The query can take the form of providing a unique identifier of the payment transceiver 104 (e.g., a serial number of other identifier) and the payment device 102, to which the server can respond by notifying payment device 102 whether it is an approved payment device. Alternatively, payment transceiver 104 can store a list of approved payment devices 102 and respond to payment device 102 with a list or approved payment devices or notifying it whether it is an approved payment device. In yet another example, payment transceiver 104 can query cloud 108 to determine whether payment device 102 is an approved payment device and can notify payment device 102 of whether it is approved to process the payment.

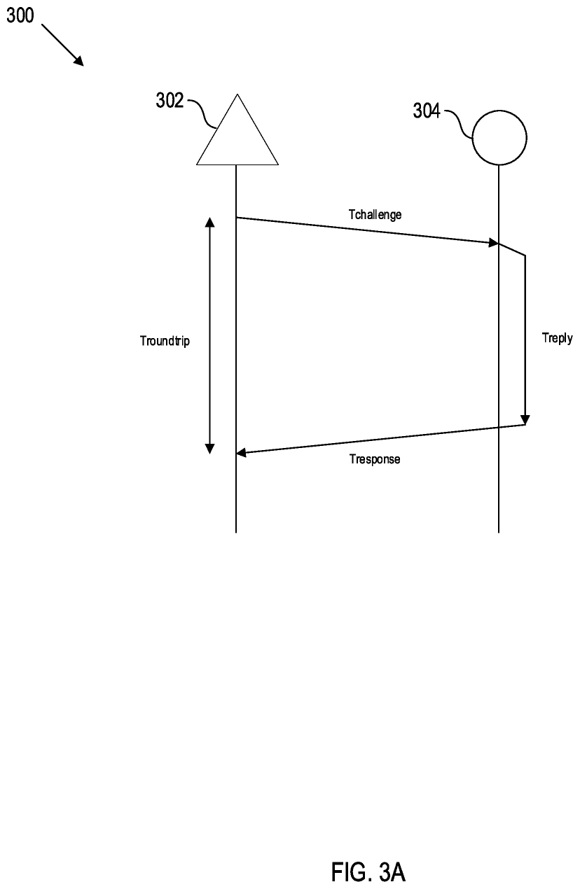

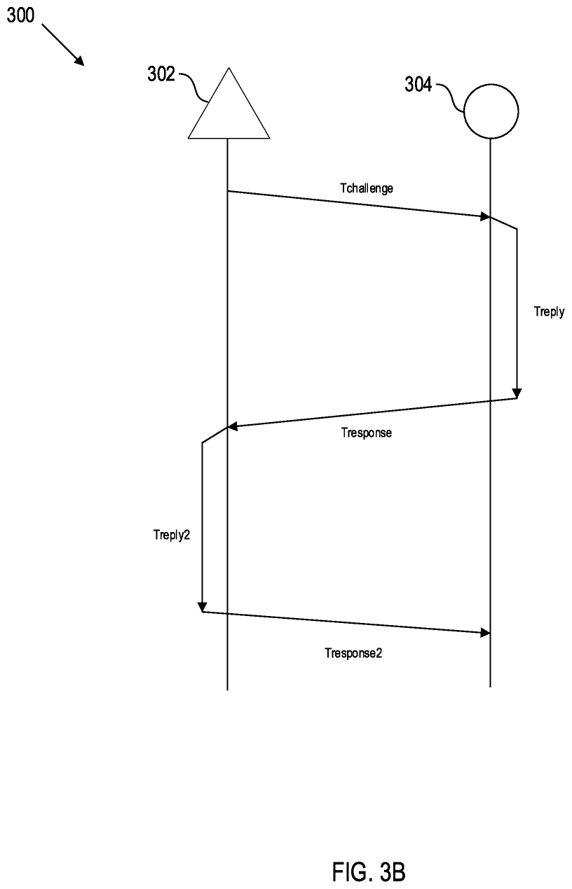

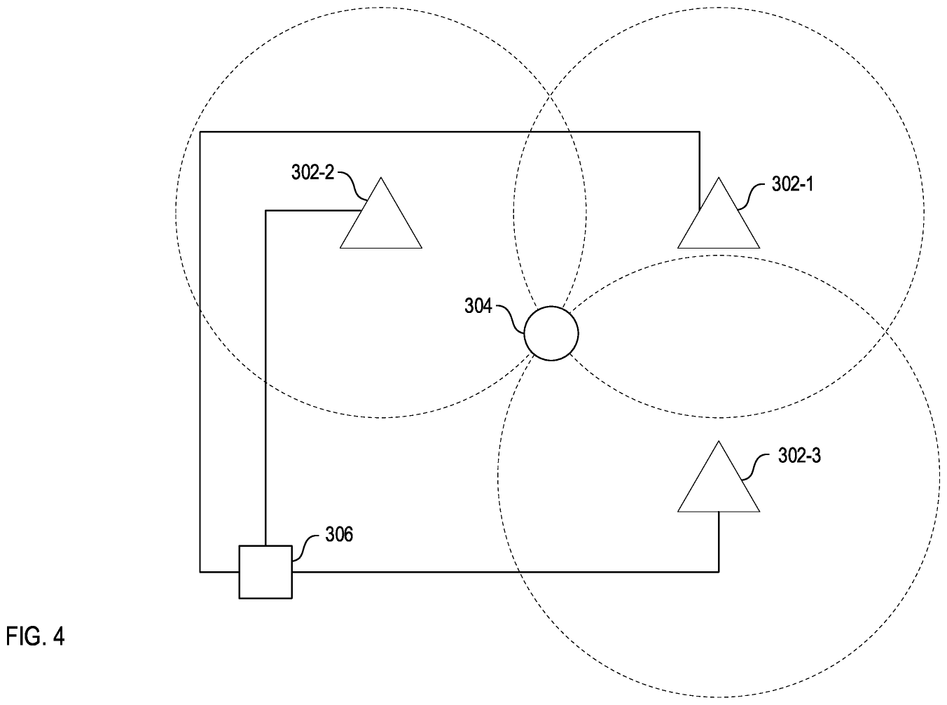

Example of methods for detecting whether a payment device 102 is within a transaction processing will be described in connection with FIGS. 3-4C. While various examples are described herein, it should be understood that these are only examples of methods for determining the range or location of the payment transceiver. Further, while these examples are described in connection with a UWB tag and UWB anchors, as described above, payment transceiver 104 can include any antenna(s) that operate with bandwidth suitable for detecting the range/location of the payment transceiver with substantial accuracy. A person of ordinary skill in the art will understand how to implement these and other methods of determining range or location with UWB or other types of antennas or protocols. For example, rather than a UWB tag, a UWB-equipped smart device can be substituted without altering the methods in any way. Similarly, rather than an anchor (i.e., a fixed UWB device), any suitable UWB-equipped device can be substituted without altering the methods.

As shown in FIG. 3, ranging can be determined using a time-of-flight (ToF) measurement. In this example, ToF is calculated by measuring total time required for a response to an initial challenge packet. As shown, UWB anchor 302 initiates a ranging request by sending a challenge packet to UWB tag 304 (acting as a payment transceiver 104), which responds with a response packet. The total time required for the challenge packet to travel to the UWB tag 304 (Tchallenge), for the UWB tag 304 to receive and generate the response packet (Treply), for the response packet (Tresponse) to travel to the UWB anchor 302 (Tresponse) is denoted as Troundtrip. The range can be determined by multiplying the difference of the roundtrip time (Troundtrip) and the reply time (Treply) of the signal by the speed of light and then dividing by two.

While the UWB anchor 302 is shown as initiating the ranging request, it should be understood that, in other examples, the UWB tag 304 can initiate the ranging request. Further, the example shown in FIG. 3 is an example of one-way ranging—i.e., the ToF is calculated from a single challenge packet and response packet—in alternative examples, two-way ranging, in which the device initially sending the challenge packet, itself responds to the response packet. The six timestamps generated from the two-way ranging methods can be used to calculate ranging between UWB anchor 302 and UWB tag 304 and can further resolve any ambiguities introduced from unsynchronized oscillators in the devices.

It should be understood that range simply refers the distance between UWB anchor 302 and UWB tag 304—it does not refer to the precise location of the UWB tag 304, which is typically expressed as a set of coordinates in some known space. (Although range is considered one method of location-based payment access.) Further, while the one-way ranging and two-ranging are provided as examples, it should be understood that any suitable method of determining range between the two devices can be used.

While detecting a range or location is described above, it should be understood that this information can be processed or stored in a variety of ways. For example, ranging may be determined from time-of-flight information (e.g., the difference between Troundtrip and Treply) without converting this to units (e.g., meters) that represent a range or to a set of coordinates that represent location. Because data such as time-of-flight information correlates to range, it is not strictly necessary to internally convert this data and can instead be used directly.

In an alternative example, instead of determining range between the devices, the location can be determined. As shown in FIG. 4, to determine the location—rather than only range—of the UWB tag 304, a plurality of anchors 302-1, 302-2, 302-3 can each perform ranging (e.g., one-way or two-way ranging) and the location of the UWB tag can be triangulated, according to the determined ranges. (This method is also referred to as time-difference of arrival.) In an example, this can be accomplished by employing timestamps, respectively received from each anchor 302-1, 302-2, 302-3, to determine the range from the UWB tag 304 to the respective UWB anchor 302-1, 302-2, 302-3. From these ranges, a processor 306, programmed to perform a multilateration algorithm, can determine the location of the UWB tag relative to the anchors 302-1, 302-2, 302-3. While, generally, three or more antennas performing ranging are required to unambiguously determine the location of UWB tag 304, in an alternative example, only two antennas can be used, if some ambiguity is tolerable.

In various alternatives, other suitable ways of determining range or location are contemplated. For example, phase difference of arrival to can be used to determine both range and bearing. This example is accomplished by measuring the phase difference at two antennas (e.g., included in UWB tag or included in UWB anchor) to determine to angle of arrival of the challenge packet or other signal.

For the purposes of this disclosure, detecting whether a payment device is within a transaction processing zone requires more than simply detecting the presence of a compliant signal. For example, near-field communication devices, which are typically passive tags that respond to an interrogating signal through mutual magnetic coupling, do not provide any information of the range or location of the tag with respect to the interrogating device. Although certain types of tags (e.g., NFC) only work within a known range, this information cannot be understood to comprise a range or location.

As described above in connection with FIG. 1, payment device 102 can determine whether the payment transceiver 104 is within a payment processing zone A. In an example, this can be accomplished by including an antenna, e.g., a UWB antenna, with payment device 102 for calculating a range between payment device 102 and transceiver 104. For example, payment device 102 can be determined to compare the detected range between the antenna of payment device 102 and payment transceiver 104 to a range threshold (i.e., boundary 106 of payment processing zone A). If payment transceiver 104 is within the threshold range of boundary 106, payment device 102 can determine whether it is an approved payment device (this will be described in more detail below) and, if so, begin processing the payment. In this example, payment device 102 can operate as the anchor of the ranging processes described in connection with FIG. 3.

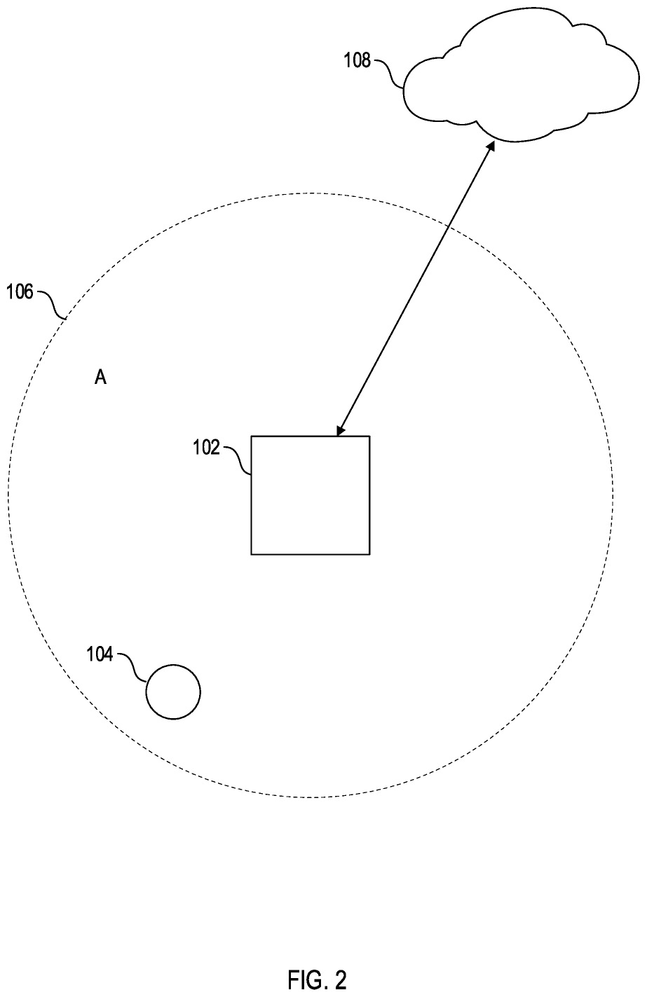

Although FIG. 2 depicts payment device 102 as being located within the center of payment processing zone A, this is only one example of a way the payment processing zone can be implemented. In another example, the antenna of payment device 102 can be deployed remote from the remainder of payment device 102. For example, the antenna can be deployed at a checkout line—the ranging threshold of payment processing zone A being determined with respect to the antenna—while the controller of payment device 102, receiving the input from payment transceiver 104 and calculating the range and completing the other functions of payment device 102, can be located remote from the checkout line.

If multiple payment devices 102 are located within a retail space, each payment device 102 can include its own antenna to implement a respective payment processing zone based on range from the antenna.

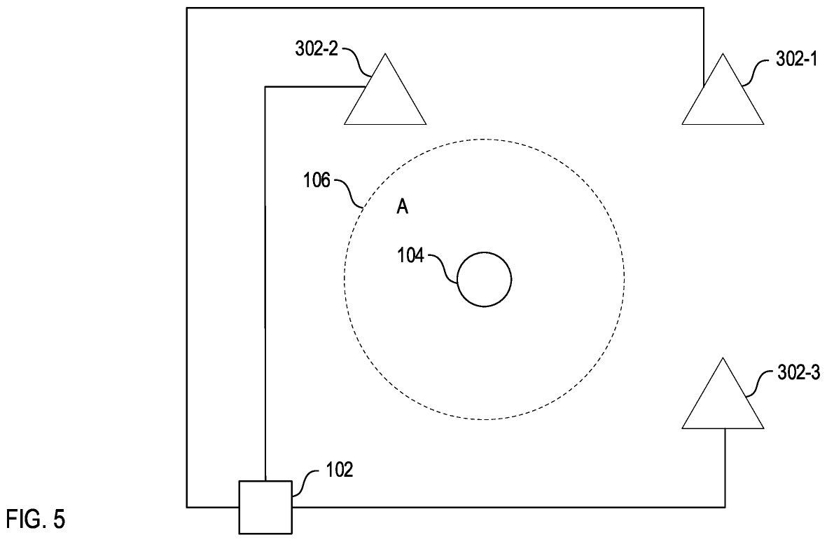

In an alternative example, multiple antennas can be used to triangulate the location of payment transceiver 104. An example of this is shown in FIG. 5, in which payment device 102 is communication with multiple UWB anchors 302-1, 302-2, 302-3. In this example, payment device 102 can calculate the location of payment transceiver 104 in accordance with, e.g., a multilateration algorithm. By calculating the location of payment transceiver 104, rather than range, payment processing zone A can be implemented at any location within range of UWB anchors 302-1, 302-2, 302-3—it need not be centered about an antenna. Further, outer boundary 106 of payment processing zone A can adopt any shape, since it is compared relative to coordinates of payment transceiver 104, not a range from an antenna.

In addition, the antennas used to determine the location of payment transceiver 104 can be used to provide the location of payment transceiver 104 to multiple payment devices 102 concurrently. For example, if multiple payment devices 102 are located within a retail environment, a plurality of antennas (e.g., UWB anchors 302-1, 302-2, 302-3) can be used to determine whether payment transceiver 104 is within one of a plurality of payment processing zones (e.g., A1, A2, A3, etc.) In this example, each of the plurality of payment devices 102 can be in communication with the antennas disposed about the retail environment and can each calculate the location of payment transceiver 104. Alternatively, a single processor (e.g., processor 306) can perform the mutlilateration calculation and provide each payment device 102 with encoded data (e.g., over a wired or wireless connection) representing the location (e.g., coordinates) of payment transceiver 104, each of which compares the location against a predetermined payment zone implemented by the respective payment device.

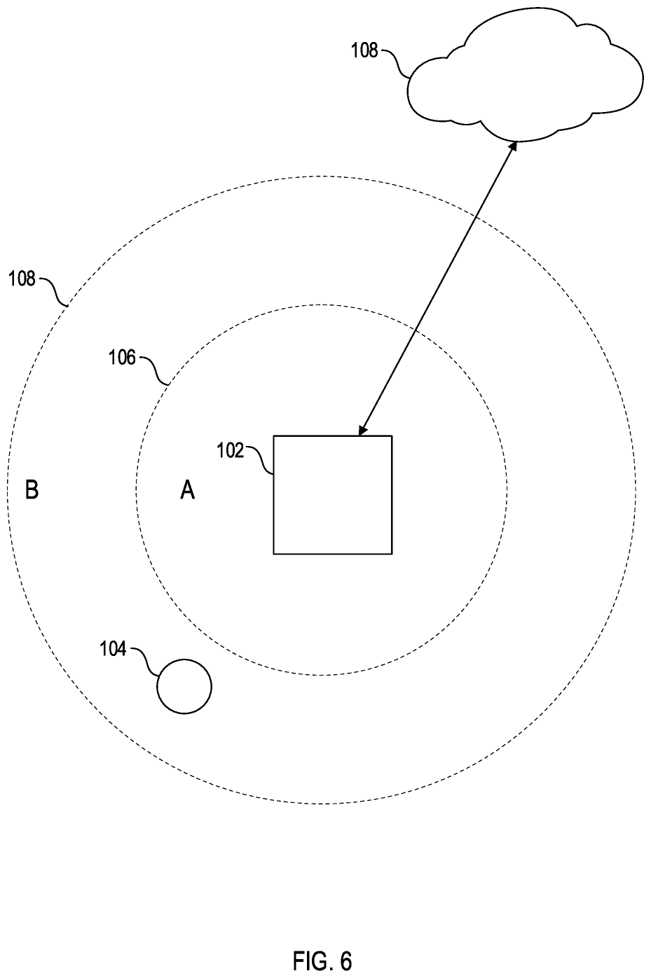

As shown in FIG. 6, a payment device approval zone B, defined by boundary 110 and existing outside of or apart from payment processing zone A, can be a defined zone in which payment device 102 determines whether it is approved to process payments from a given payment transceiver 104 before entering the payment processing zone A. For example, as payment transceiver 104 enters payment device approval zone B before entering payment processing zone A, payment device 102 can determine (e.g., by querying remote server(s) 108) whether it is approved to process payment from payment transceiver 104. If payment device 102 is approved, when payment transceiver 104 enters payment processing zone A, payment device 102 will not need to determine whether it is approved (as it has already done so) and thus will be able to process the payment in a faster and more efficient manner.

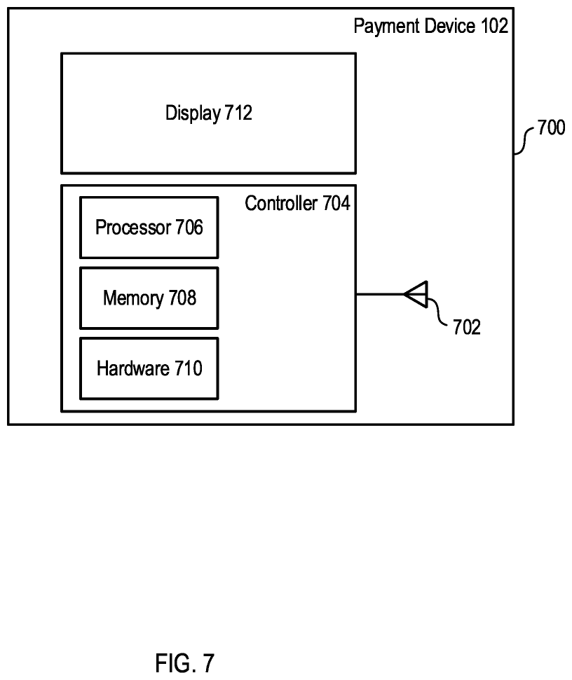

FIG. 7 depicts a schematic diagram of an example payment device 102, focusing primarily on processing and components useful for completing the functions and methods described in this disclosure. As shown, payment device 102, in this example, a includes a housing 700, an antenna 702, a controller 704, comprising processor 706, memory 708, and associated hardware 710, and a display 712. To focus more on the pertinent features of payment device 102, not shown in FIG. 7 are components for receiving payments via magnetic stripe, a chip, or NFC, components for connection to a network, such as a payment processing network, components for receiving power (e.g., a power supply), etc, which can be present in various examples of payment device 102.

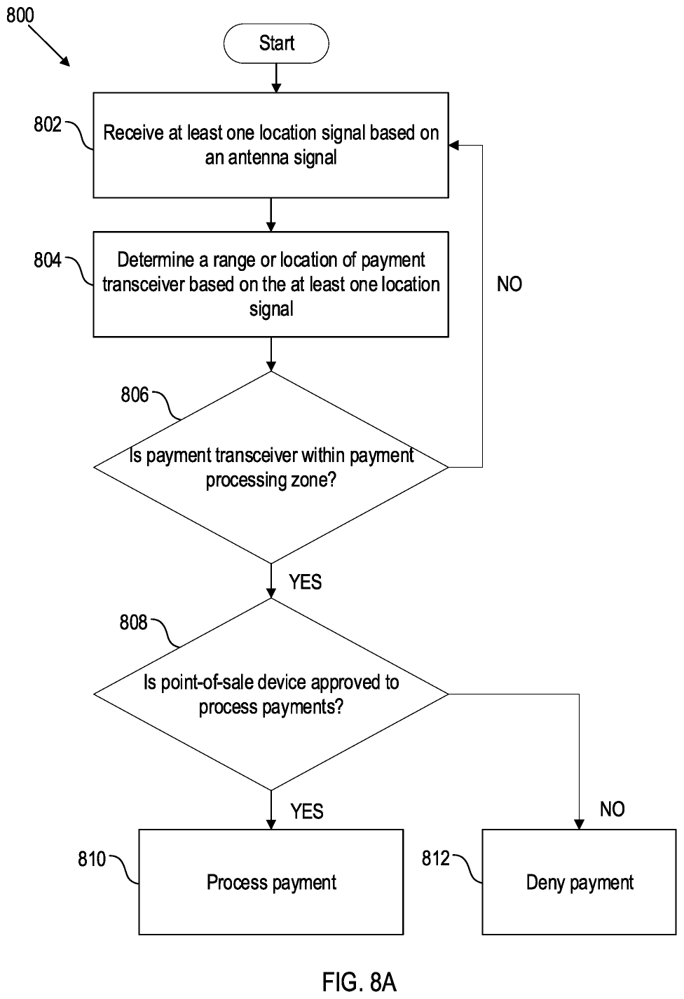

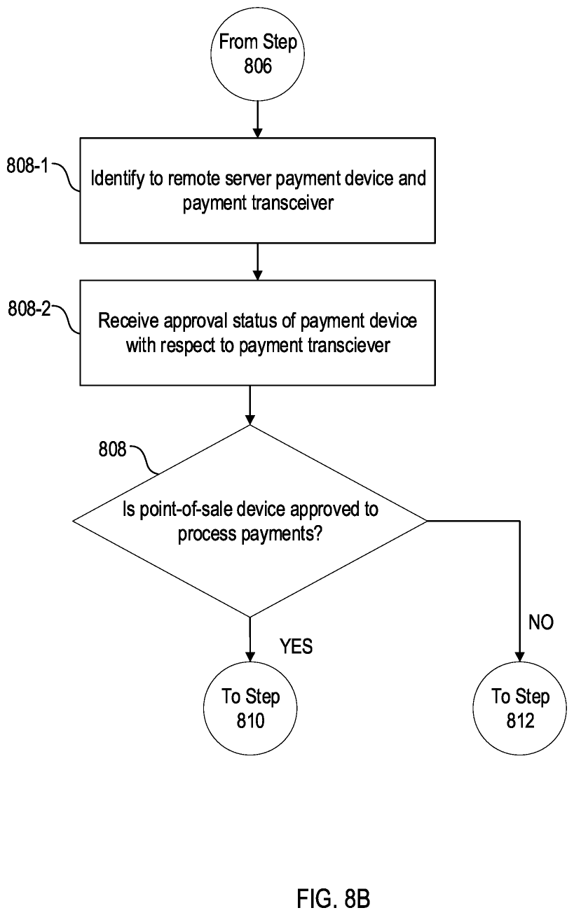

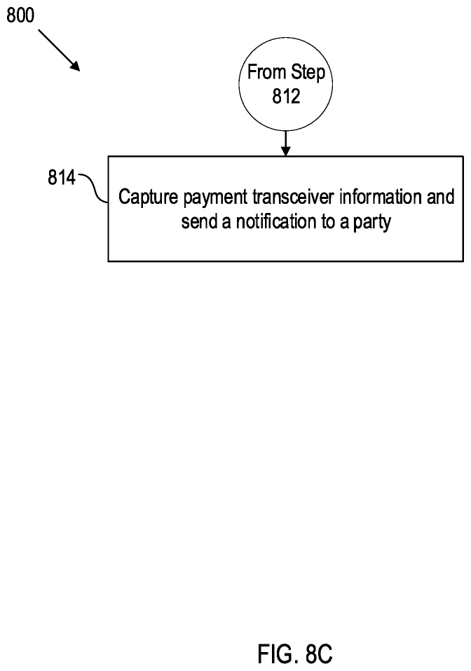

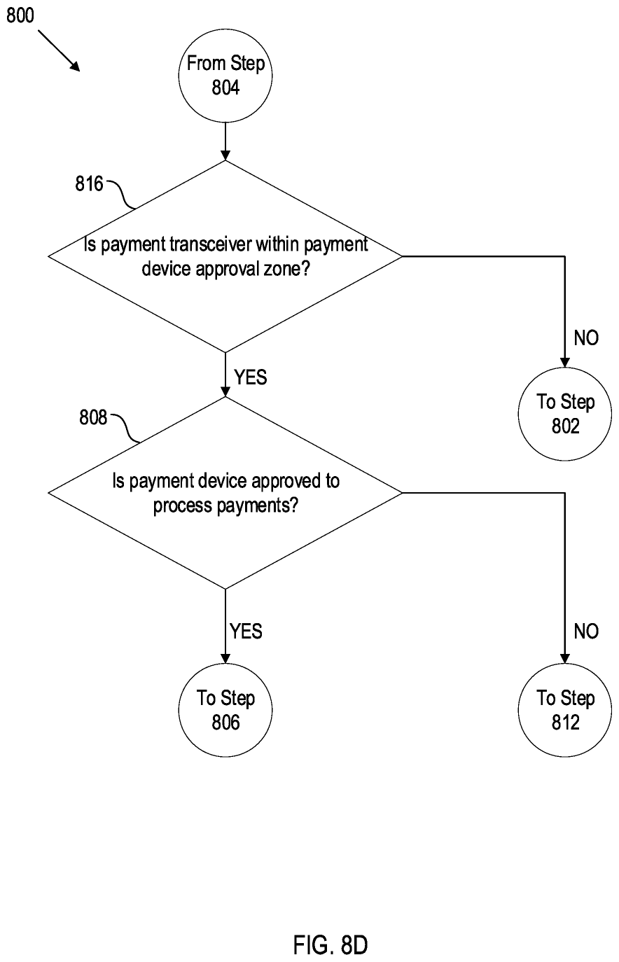

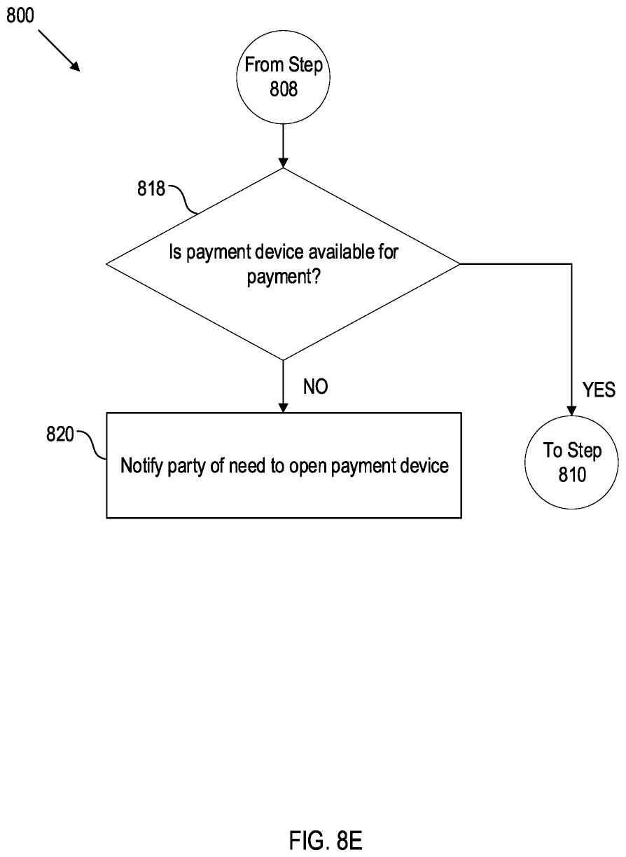

Controller 704 can be one or more processors 706, and any associated hardware 710, configured to execute at least one step (e.g., the steps described in connection with the method of FIG. 8) stored in a non-transitory storage medium, such as memory 708, to perform the various function described in this disclosure (e.g., receiving a location signal, determining range/location, determining whether the payment transceiver is within the payment processing zone, etc.). For example, controller 704 can be a microprocessor or microcontroller executing steps stored in memory 708 (either as firmware or software). Antenna 702, as described above, can be any suitable antenna for determining a range to a payment transceiver. Although antenna 702 is shown disposed within housing 700, it should be understood that in, alternative examples, antenna 702 can be disposed on housing 700, extending from housing 700, or remote from housing 700. Further, in various alternative examples, as described above, controller 704 can receive signals from multiple antennas and/or encoded data from processors in communication with one or more antennas. Display 712 can be employed to notify a user of information such as totals before the payment is approved, and status updates on the processing, such as approval or denial.

FIGS. 8A-8E depict a method 800 for implementing location-based (including range-based) payment access. Method 800 can be performed by a controller, such as controller 704, which typically includes one or more processors configured to execute at least one step of method 800 stored in a non-transitory storage medium, and any associated hardware.

At step 802 at least one location signal, based on at least one antenna signal (i.e., as an antenna signal or derived from an antenna signal), is received. The location signal can be any signal, based on an antenna signal, from which the range and/or location of a payment transceiver can be determined, and which represents the location or range of the payment transceiver (i.e., is a signal from which the location or range can be derived). In one example, the location signal is one or more antenna signal(s) from an antenna in electrical communication with the payment device. The antenna signal(s) can be amplified or processed (e.g., filtered) before being received by the payment device (it is also contemplated that payment device itself can amplify or filter the antenna signal). In one example, the antenna signal is received from an antenna associated with the retail device; for example, the antenna is disposed on or within the payment device or extends from the payment device.

Additional antenna signals can be received from antennas disposed about the retail environment, and which can, themselves, be associated with other payment devices. In another example, the payment device can receive the one or more antenna signal(s) from one or more antennas disposed about the retail environment, with no one antenna being disposed within or extending from the payment device. Such antenna(s) can, in an example, be disposed remote to the payment device.

In an alternative example, the payment device can receive the location signal from one or more processor(s) external to payment device. The one or more processor(s) can perform initial processing to the antenna signal to derive data that is encoded and delivered to the payment to the payment device (as the location signal). The encoded location signal can be, for example, time-of-flight data, such as timestamps that represent events in a one-way or two-way ranging exchange between an antenna and payment transceiver. Alternatively, the location data can be encoded data representing the range of the payment transceiver from at least one antenna, or can be encoded data representing the location of the payment transceiver within a predefined volume (e.g., the external processor has received antenna signals from a plurality of antennas and has performed a multilateration calculation to determine the relative location of the payment transceiver).

The above-described location signals are only examples of suitable location signals. A person of ordinary skill in the art will understand that any location signal, as received or derived from at least one antenna signal, that represents or can be used to determine the range of payment transceiver from an antenna, or a location of the payment transceiver within a predefined volume, can be used.

Further, while one or more UWB antennas are expressly contemplated, any suitable type of antenna(s) that operate in a bandwidth to provide substantially accurate (i.e., ranging or location information as determined in this step or below), can be used.

At step 804 a range or location of the payment transceiver is determined based on the at least one location signal. This step is an optional step, depending on the nature of the location signal received in step 802. For example, if the location signal is an antenna signal from an antenna in electrical communication with the payment device, payment device can originate a challenge packet, and timestamp all signals sent to and received from the payment transceiver to determine the ToF from the payment transceiver. The ToF can then, optionally, be converted to a distance measurement from the transceiver.

In another example, if the payment device is in communication with multiple such antennas disposed about the retail environment, this process can be repeated to determine ranging from each antenna. The ranging from multiple antennas can be used to perform a multilateration calculation to triangulate the location of the payment transceiver within the predefined volume (i.e., space within range of antennas, such as a retail environment). In an alternative example, the range or location can be determined from encoded ToF data received from one or more external processors.

In an alternative example, this step can be skipped if the range or location data completed by and received from an external processor and thus does not require any additional processing to perform step 806.

Step 806 is conditional block that determines whether the payment transceiver is within a predefined payment processing zone, according to the range or location. If range is used, the payment processing zone can be a range threshold, representing a circular range zone centered about the antenna. In this example, step 806 compares the determined range to the range threshold that represents the zone. If the range is less than the threshold amount, the payment transceiver is within the payment processing zone and the method proceeds to step 808. If not, then the method returns to step 802 to start the process of determining an updated range.

If location is used, payment processing zone can take any shape or form as desired. In this case, step 806 comprises comparing the location data (e.g., coordinates) to determine whether the location of the payment transceiver is disposed within the boundaries of the payment processing zone. If the payment transceiver is determined to have a location with the payment processing zone, the method proceeds to step 808. If not, then the method returns to step 802 to start the process of determining an updated location.

Step 808 represents a decision block to determine whether the payment device is an approved payment device. A user can preselect a set of payment devices that are approved for processing payments. (In an example, the preselected set of payment devices can default to all payment devices but for action by the user to select certain payment devices as approved.) The user can preselect the approved payment devices through a smart device application or through a website. Alternatively, the user can make selections and store those selections locally on the smart transceiver (e.g., if the smart transceiver is a smart device).

In an example, payment device can determine its status as an approved (or unapproved) payment device by querying remote server(s) or the payment transceiver itself. For example, turning briefly to FIG. 8B, step 808 can include the preliminary substep 808-1 of identifying the payment device and the payment transceiver to a remote server as part of request for the approval status of the payment device with respect to the payment transceiver (i.e., is the payment device approved to process payments from the payment transceiver?). At substep 808-2 the approval status can be received from the remote server.

In alternative examples, payment device can send data identifying itself to the payment transceiver as part of a query to the payment transceiver to determine whether the payment device is approved to process payments. From the identification information, payment transceiver can either check local storage to determine if payment device is approved or it can query the remote server (i.e., perform step 808-1 itself) for the approval status of the payment device. In another example, payment device can request a list of approved payment devices from the remote server or the payment transceiver, and can determine, from the list, whether it is an approved payment device.

Regardless, if the payment device is approved to process payments from the payment transceiver, the method proceeds to step 810, otherwise it proceeds to step 812.

At step 810, the payment device processes the payment through a network connection to a payment processor. It should be understood that the payment device will have been considered to have processed the payment regardless of whether the payment is denied by the remote payment processor.

At step 812, the payment device denies processing the payment. This can include an additional step of notifying the payment transceiver that the payment will not be processed. Additionally, as shown in FIG. 8C, at step 814, information related to the payment transceiver (e.g., identification information) can be captured, and a party, such as the payment processor, can be notified that a payment was attempted at the payment device, and denied, for the purposes of tracking.

In an alternative example, as shown in FIG. 8E, the payment device can be pre-approved before the payment transceiver enters the payment processing zone. In this example, after step 804, step 816 represents a decision block to determine whether the payment transceiver is with a payment device approval zone. The payment device approval zone is generally larger or disposed in a location distinct from the payment processing zone, such that a customer carrying the payment transceiver enters the payment device approval zone before entering the payment processing zone. If only a range is between an antenna and the payment transceiver is determined or received in the earlier steps, then the payment device approval zone is a range threshold that is larger than the payment processing zone (as shown, for example, in FIG. 6). (In one example, the payment processing zone can be the outer range of the antenna.) If the range between the antenna and payment transceiver is calculated, step 816 is accomplished by determining whether the calculated range is less than the outer ranger threshold of the payment device approval zone.

However, if a location (e.g., coordinates) is determined or received in the above steps, then the payment device approval zone can assume any desired shape. Typically, this shape is selected such that a user travels through the payment device approval zone before reaching the payment processing zone (e.g., in a checkout line). If the location is determined or received in the above steps, then this step can be accomplished by comparing the location (e.g., coordinates) to payment device approval zone to determine whether the payment transceiver is located within it.

If the result of step 808 is that, if the payment device is approved, the method proceeds to step 806, but, in this variation, the payment device having already been approved, step 808 is skipped after completing step 806. If the result of step 808 is that the payment device is not approved to process payments, and any future attempts pay the payment transceiver to process payments in the payment processing zone can be denied or ignored.

In a further example, payment device can at step 818 to determine whether the payment device is currently open for processing payments. If the user is detected within the payment processing zone and the payment device is approved for payments, but the payment device is not currently open for use, a party, such as a manager, can be notified to come open the payment device as step 820. Otherwise, the method proceeds to steps 810 to process the payment.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

The above-described examples of the described subject matter can be implemented in any of numerous ways. For example, some aspects may be implemented using hardware, software or a combination thereof. When any aspect is implemented at least in part in software, the software code can be executed on any suitable processor or collection of processors, whether provided in a single device or computer or distributed among multiple devices/computers.

The present disclosure may be implemented as a system, a method, and/or a computer program product at any possible technical detail level of integration. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some examples, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to examples of the disclosure. It will be understood that each block of the flowchart illustrations and/or block diagrams, and combinations of blocks in the flowchart illustrations and/or block diagrams, can be implemented by computer readable program instructions.

The computer readable program instructions may be provided to a processor of a, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various examples of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Other implementations are within the scope of the following claims and other claims to which the applicant may be entitled.

While various examples have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the examples described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific examples described herein. It is, therefore, to be understood that the foregoing examples are presented by way of example only and that, within the scope of the appended claims and equivalents thereto, examples may be practiced otherwise than as specifically described and claimed. Examples of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

What is claimed is:

1. A payment device, comprising:
a housing; and
a controller disposed within the housing and configured to:
receive at least one location signal, the at least one location signal being based, at least in part, on an antenna signal and representing a location of a payment transceiver or a range between the payment transceiver and an antenna;
determine, according to the at least one location signal, whether the location of the payment transceiver is within a payment processing zone;
determine whether the payment device is an approved payment device such that the payment device is approved to process payments from the payment transceiver; and
process a payment from the payment transceiver only if, at least, the payment transceiver is within the payment processing zone and the payment device is an approved payment device.

2. The payment device of claim 1, wherein the at least one location signal is the antenna signal.

3. The payment device of claim 2, wherein determining whether the payment device is within the payment processing zone comprises determining the range between the payment transceiver and the antenna according to the antenna signal and comparing the range to a range threshold.

4. The payment device of claim 1, wherein the at least one location signal is a plurality of antenna signals, respectively received from a plurality of antennas.

5. The payment device of claim 4, wherein determining whether the payment device is within the payment processing zone comprises:
determining a range between the payment transceiver and each antenna of the plurality of antennas;
determining the location of the payment transceiver according to the range between the payment transceiver and each antenna of the plurality of antennas; and
determining whether the location of the payment transceiver is within a boundary of the payment processing zone.

6. The payment device of claim 1, wherein the location signal is encoded data representing a location of the payment device, wherein determining whether the payment device is within the payment processing zone comprises determining whether the location of the payment transceiver is within a boundary of the payment processing zone.

7. The payment device of claim 1, wherein payment device is an ultra-wide band tag or a smart device equipped with an ultra-wide band antenna.

8. The payment device of claim 1, wherein determining whether the payment device is an approved payment device, comprises the step of querying a remote server for an approval status of the payment device with respect to the payment transceiver.

9. The payment device of claim 1, wherein determining whether the payment device is an approved payment device, comprises the step of querying the payment transceiver for an approval status of the payment device with respect to the payment transceiver.

10. The payment device of claim 1, wherein the controller is further configured to determine, according to the at least one location signal, whether the location of the payment transceiver is within a payment device approval zone, wherein the step of determining whether the payment device is an approved payment device occurs if the payment transceiver is within the payment device approval zone.

11. A method for payment access according to location or range, comprising:
receiving at least one location signal, the at least one location signal being based, at least in part, on an antenna signal and representing a location of a payment transceiver or a range between the payment transceiver and an antenna;
determining, according to the at least one location signal, whether the location of the payment transceiver is within a payment processing zone;
determining whether a payment device is an approved payment device such that the payment device is approved to process payments from the payment transceiver; and
processing a payment from the payment transceiver only if, at least, the payment transceiver is within the payment processing zone and the payment device is an approved payment device.

12. The method of claim 11, wherein the at least one location signal is the antenna signal.

13. The method of claim 12, wherein determining whether the payment device is within the payment processing zone comprises determining the range between the payment transceiver and the antenna according to the antenna signal and comparing the range to a range threshold.

14. The method of claim 11, wherein the at least one location signal is a plurality of antenna signals, respectively received from a plurality of antennas.

15. The method of claim 14, wherein determining whether the payment device is within the payment processing zone comprises:
determining a range between the payment transceiver and each antenna of the plurality of antennas;
determining the location of the payment transceiver from the range between the payment transceiver and each antenna of the plurality of antennas; and
determining whether the location of the payment transceiver is within a boundary of the payment processing zone.

16. The method of claim 11, wherein the location signal is encoded data representing a location of the payment device, wherein determining whether the payment device is within the payment processing zone comprises determining whether the location of the payment transceiver is within a boundary of the payment processing zone.

17. The method of claim 11, wherein payment device is an ultra-wide band tag or a smart device equipped with an ultra-wide band antenna.

18. The method of claim 11, wherein determining whether the payment device is an approved payment device, comprises the step of querying a remote server for an approval status of the payment device with respect to the payment transceiver.

19. The method of claim 11, wherein determining whether the payment device is an approved payment device, comprises the step of querying the payment transceiver for an approval status of the payment device with respect to the payment transceiver.

20. The method of claim 11, further comprising the step of: determining, according to the at least one location signal, whether the location of the payment transceiver is within a payment device approval zone, wherein the step of determining whether the payment device is an approved payment device occurs if the payment transceiver is within the payment device approval zone.
